(19) United States
(12) Patent Application Publication
(10) Pub. No.: US 2024/0311182 A1
(43) Pub. Date: Sep. 19, 2024

(54) Multi-Tree Reduction with Execution Skew

(71) Applicant: Advanced Micro Devices, Inc., Santa Clara, CA (US)

(72) Inventors: Kishore Punniyamurthy, Austin, TX (US); Sagnik Basu, Madison, WI (US); Khaled Hamidouche, Austin, TX (US); Brandon Keith Potter, Troup, TX (US)

(73) Assignee: Advanced Micro Devices, Inc., Santa Clara, CA (US)

(21) Appl. No.: 18/185,641

(22) Filed: Mar. 17, 2023

(51) Int. Cl. G06F 9/48

(52) U.S. Cl. CPC G06F 9/4881

(57) ABSTRACT

A device includes a communication scheduler to generate schedule trees for scheduling data communication among a plurality of nodes configured to perform a collective operation using data contributed from the plurality of nodes. The device includes data reduction logic to: identify one or more skewed nodes among the plurality of nodes, perform, according to a first set of schedule trees, a first operation to generate partial results based on data contributed from non-skewed nodes, and perform, according to a second set of schedule trees, a second operation to generate final results based on the partial results and data contributed from the one or more skewed nodes.

### BACKGROUND

Some parallel computing systems used in data processing applications (e.g., machine learning) rely on a network of nodes to perform a collective operation (e.g., all-to-all, all-reduce, etc.). Typically, a node passes messages to other nodes via a communication path that is based on a network topology of the system. As such, system performance could be limited by network contention due to bandwidth constraints between connected nodes.

### BRIEF DESCRIPTION OF THE DRAWINGS

FIG. 1 is a block diagram of a non-limiting example distributed computing system for performing a collective operation and multi-tree reduction with execution skew.

FIG. 2 depicts a non-limiting example of a collective operation in the distributed computing system.

FIG. 3 depicts a non-limiting example system in which collective communications are scheduled according to a skew-tolerant multi-tree approach.

FIG. 4 depicts a non-limiting example system having a fat-tree network topology and configured to perform a skew-tolerant multi-tree collective operation.

FIG. 5 depicts a procedure in an example implementation of skew-tolerant multi-tree reduction.

### DETAILED DESCRIPTION

### Overview

Synchronization delay due to skew in execution across a network of nodes may present a challenge for achieving optimal performance of collective communications. For example, a node may delay performing a computation that relies on an input from another node until it receives such input or a node may be implemented using different (e.g., less performant) hardware. This can occur in a scenario where some computing hardware in a data center is updated while other computing hardware is not updated. In general, a skewed node is a node that is unavailable (e.g., not ready) to provide data for a collective operation (e.g., all-reduce) when the skewed node is scheduled to provide such data.

One example collective operation is an all-reduce operation. In an all-reduce operation, a group of nodes is assigned to perform a data reduction operation (e.g., sum, product, maximum, etc.) on a data chunk collectively. In scenarios, each node is responsible for reducing a portion of the data chunk (e.g., calculate the sum of two elements) and passing the reduced output to another node, and so on, until a reduced data output is calculated. The reduced data output (e.g., sum of hundreds or thousands of individual data elements, etc.) is then broadcast to the other nodes (e.g., via an all-gather operation) so that the final results are available to the other nodes.

An example multi-tree scheduling process for performing a collective operation (e.g., all-reduce) involves generating a custom multi-tree communication schedule for the nodes that is used to avoid over-subscription of links between the nodes. In the absence of execution skew, a multi-tree approach typically achieves better performance for data heavy workloads (e.g., large message sizes) than other approaches. However, most conventional multi-tree scheduling systems assume an absence of execution skew, which is generally unrealistic given the realities of computing hardware deployments, and thus conventional systems experience reduced performance due to execution skew. Further, traditional techniques like using barriers to delay execution by non-skewed nodes until skewed nodes are ready to contribute data eliminate or reduce performance gains associated with the multi-tree scheduling approach.

Multi-tree reduction with execution skew is described. In one or more implementations, the skew-tolerant multi-tree scheduling procedure described herein minimizes the delay associated with execution skew by generating partial reduction results using data from non-skewed nodes and then combining the partial results with data contributed from skewed nodes at a later time (e.g., during the gathering stage) to generate the final reduction results. This reduces an overall execution delay relative to conventional approaches by partially reducing available data from non-skewed nodes while waiting for data from skewed nodes to become available.

In some aspects, the techniques described herein relate to a system including: a communication scheduler to generate schedule trees for scheduling data communication among a plurality of nodes configured to perform a collective operation using data contributed from the plurality of nodes; and data reduction logic to: identify one or more skewed nodes among the plurality of nodes, perform, according to a first set of schedule trees, a first operation to generate partial results based on data contributed from non-skewed nodes, and perform, according to a second set of schedule trees, a second operation to generate final results based on the partial results and data contributed from the one or more skewed nodes.

In some aspects, the techniques described herein relate to a system, wherein the data reduction logic is configured to identify a skewed node based on a determination that the skewed node is unavailable to contribute data according to the first set of schedule trees.

In some aspects, the techniques described herein relate to a system, wherein the data reduction logic is to perform the first operation to generate the partial results without the data contributed from the one or more skewed nodes.

In some aspects, the techniques described herein relate to a system, wherein the communication scheduler is to generate the second set of schedule trees based on identifying the one or more skewed nodes.

In some aspects, the techniques described herein relate to a system, wherein to perform the second operation according to the second set of schedule trees the data reduction logic is further configured to distribute the final results to the plurality of nodes.

In some aspects, the techniques described herein relate to a system, further including a network interface controller configured to perform a probe operation and the data reduction logic identifies the one or more skewed nodes based on the probe operation.

In some aspects, the techniques described herein relate to a system, wherein the network interface controller is to update, based on the probe operation, a bitmap that includes a bit for each of the plurality of nodes, wherein the bit is indicative of whether a corresponding node is available to contribute data for the collective operation.

In some aspects, the techniques described herein relate to a system, wherein the data reduction logic is further configured to trigger performance of the second operation in response to a determination that at least one of the one or more skewed nodes is available to contribute data according to the second set of schedule trees.

In some aspects, the techniques described herein relate to a system, wherein the data reduction logic is further configured to trigger performance of the second operation in response to a determination that all the one or more skewed nodes are available to contribute data according to the second set of schedule trees.

In some aspects, the techniques described herein relate to a system, wherein the data reduction logic is further configured to trigger performance of the first operation in response to a determination that at least a threshold number of the plurality of nodes are non-skewed.

In some aspects, the techniques described herein relate to a method including: generating schedule trees for scheduling data communication among a plurality of nodes configured to perform a collective operation; identifying one or more skewed nodes among the plurality of nodes; performing, according to a first set of schedule trees, a first operation to generate partial results based on data contributed from non-skewed nodes; and performing, according to a second set of schedule trees, a second operation to generate final results based on the partial results and data contributed from the one or more skewed nodes.

In some aspects, the techniques described herein relate to a method, further including: identifying a skewed node based on a determination that the skewed node is unavailable to contribute data according to the first set of schedule trees.

In some aspects, the techniques described herein relate to a method, further including performing the first operation to generate the partial results without the data contributed from the one or more skewed nodes.

In some aspects, the techniques described herein relate to a method, further including generating the second set of schedule trees based on identifying of the one or more skewed nodes.

In some aspects, the techniques described herein relate to a method, further including broadcasting the final results to the plurality of nodes.

In some aspects, the techniques described herein relate to a method including: generating schedule trees for scheduling collective communications among a plurality of nodes; identifying one or more skewed nodes among the plurality of nodes; performing, according to a first set of schedule trees, a first operation to generate partial results based on data contributed from non-skewed nodes; and performing, according to a second set of schedule trees, a second operation to generate final results based on the partial results and data contributed from the one or more skewed nodes.

In some aspects, the techniques described herein relate to a method, wherein a skewed node is a node that is unavailable to contribute data according to the first set of schedule trees.

In some aspects, the techniques described herein relate to a method, further including performing the first operation to generate the partial results without the data contributed from the one or more skewed nodes.

In some aspects, the techniques described herein relate to a method, further including generating the second set of schedule trees based on identifying the one or more skewed nodes.

In some aspects, the techniques described herein relate to a method, further including propagating the final results to the plurality of nodes.

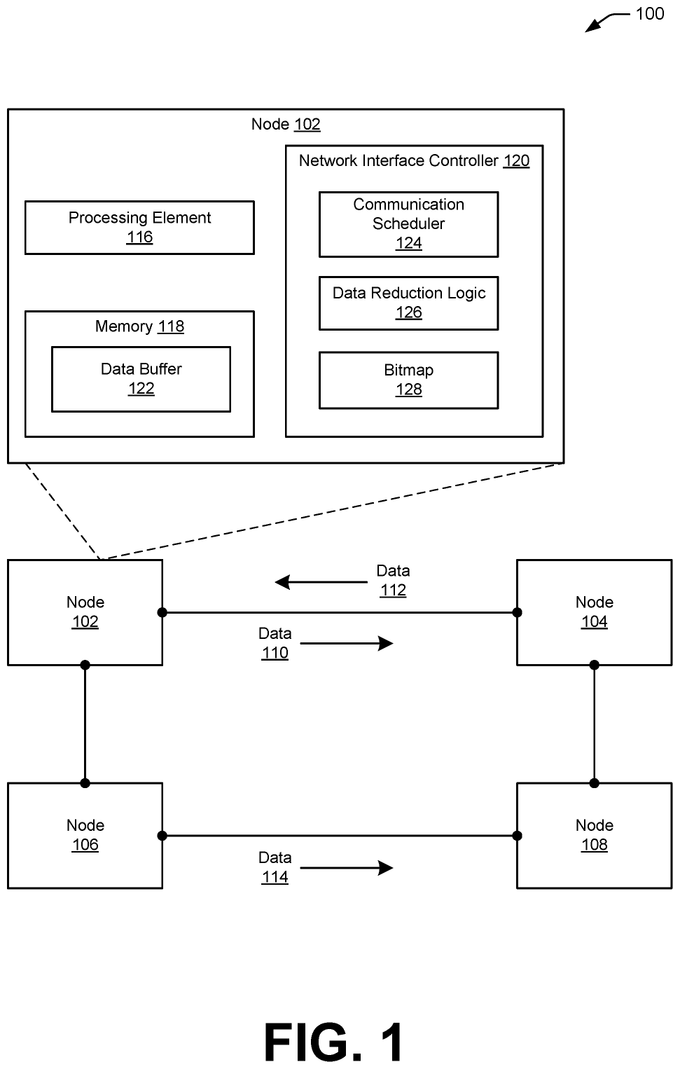

FIG. 1 is a block diagram of a non-limiting example distributed computing system 100 for performing a collective operation and multi-tree reduction with execution skew. The system 100 is as a non-limiting illustrative example of any type of distributed computing system or computing device that includes multiple system nodes 102, 104, 106, 108 interconnected according to any network topology (e.g., such as the 2×2 mesh network topology shown) to perform a collective operation in accordance with the present disclosure. Further, the illustrated example represents how a collective operation processes based on underlying procedures, library calls, hardware configurations, etc. In alternate examples, system 100 includes fewer or more nodes connected in similar or different network topologies than the network topology (2×2 mesh network) shown.

In examples, the plurality of nodes 102, 104, 106, 108 of system 100 are interconnected using data links (e.g., wired) and configured to communicate messages to one another (e.g., data 110, 112, 114, etc.) according to a communication schedule or other communication algorithm to collectively perform an operation (e.g., all-gather, all-reduce, etc.), as described herein.

In the illustrated example, node 102 includes a processing element 116, a memory 118, and a network interface controller 120. In examples, nodes 104, 106, 108 each include processing elements, memories, and network interface controllers similarly to node 102. In examples, processing element 116, memory 118, network interface controller 120 are coupled to one another via wired or wireless connections (not shown). Example wired connections include, but are not limited to, buses connecting the two or more of processing element 116, memory 118, and/or network interface controller 120. In variations, at least one of the nodes is configured differently (e.g., has more, fewer, or different components).

The processing element 116 includes any type of one or more processing units, such as graphics processing units (GPUs), central processing units (CPUs), arithmetic logic units (ALU), or any other type of processing device configured to execute computer instructions (e.g., communication scheduler 124) retrieved from a memory (e.g., memory 118) and/or other non-transitory storage medium. Although node 102 is shown to include one processing element 116, in alternate examples, node 102 includes multiple processing elements 116.

The memory 118 is a device or system that is used to store information. In an example, the memory 118 includes semiconductor memory where data is stored within memory cells on one or more integrated circuits. In an example, memory 118 corresponds to or includes volatile memory, examples of which include random-access memory (RAM), dynamic random-access memory (DRAM), synchronous dynamic random-access memory (SDRAM), and static random-access memory (SRAM). Alternatively or in addition, the memory 118 corresponds to or includes non-volatile memory, examples of which include flash memory, read-only memory (ROM), programmable read-only memory (PROM), erasable programmable read-only memory (EPROM), and electronically erasable programmable read-only memory (EEPROM).

In the illustrated example, memory 118 includes a data buffer 122. In examples, data buffer 122 stores data such as a portion of a data chunk associated with a collective operation assigned to a group of nodes (e.g., nodes 102, 104, 106, 108), partial results of the collective operation, and/or final results of the collective operation.

Network interface controller 120 includes any type of device configured to manage incoming and/or outgoing network communications (e.g., messages, data 112, data 114, etc.) between the node 102 and/or one or more nodes connected thereto (e.g., nodes 104, 106). In the illustrated example, Network interface controller 120 includes a communication scheduler 124, data reduction logic 126 and a bitmap 128. Although depicted in the Network interface controller 120, in variations the data reduction logic 126 and/or the bitmap 128 are maintained in different portions of the system 100.

In examples, communication scheduler 124 includes instructions (e.g., executable by processing element 116 and/or the network interface controller 120) and/or circuitry wired to cause the node 102 to perform one or more of the functions described herein. In an example, communication scheduler 124 is configured to generate schedule trees (e.g., according to a multi-tree approach, etc.) for scheduling collective communications between the nodes 102, 104, 106, and/or 108. Although the communication scheduler 124 is shown as a component of the network interface controller 120, in alternate examples, one or more functions of the communication scheduler 124 are implemented as part of the processing element 116 and/or the memory 118 (e.g., as instructions executable by the processing element 116).

Data reduction logic 126 includes any type of instructions, circuitry, software, and/or hardware configured to cause the Network interface controller 120 (and/or the node 102) to perform one or more of the functions described herein. In an example, data reduction logic 126 includes instructions that cause the Network interface controller 120 to send data 112 to node 104 according to a set of schedule trees (e.g., generated by communication scheduler 124).

The bitmap 128 includes any type of data structure (e.g., an array, etc.), software, and/or hardware configured to store an indication of a status (e.g., skewed, non-skewed, etc.) of a group of nodes assigned to perform a collective operation. As noted above, a skewed node is a node that is unavailable to contribute data for the collective operation. As a non-limiting example, nodes 102, 104, 106, 108 are assigned to collectively reduce a data chunk in parallel, and a processor thread executing on node 102 calls an application programming interface (API) of the collective operation before a processor thread executing in node 106 reaches the API call. In this example, bitmap 128 indicates node 102 as a non-skewed node and node 106 as a skewed node (at least until node 106 reaches the API call). In an example, the Network interface controller 120 of node 102 performs a probe operation to probe the other nodes 104, 106, 108 (directly or indirectly) and updates or stores a bit in bitmap 128 to indicate the status of each node (e.g., ‘1’ for non-skewed nodes and ‘0’ for skewed nodes, or vice versa). For instance, a bitmap of ‘1101’ in this example indicates that nodes 102, 104, and 108 are non-skewed and that node 106 is skewed. In alternate examples, the bitmap 128 has a different configuration and/or format for indicating the status of the group of nodes.

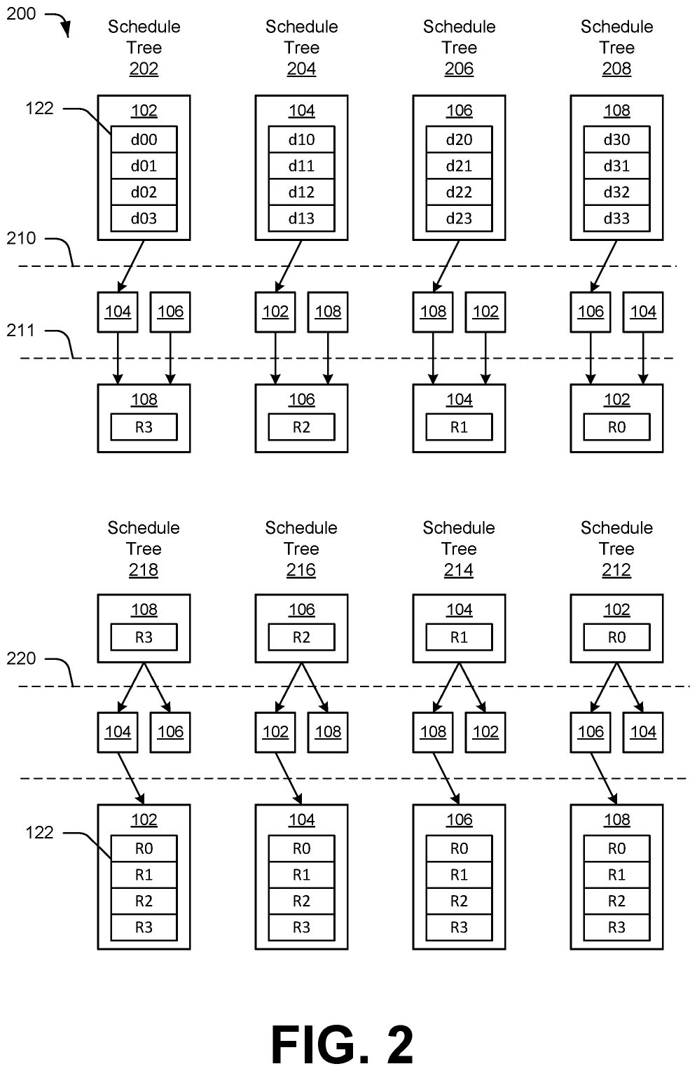

FIG. 2 depicts a non-limiting example of a collective operation implemented in a distributed computing system 200. In the illustrated example, input data (e.g., a data chunk) is distributed among the plurality of nodes 102, 104, 106, 108. In the scenario of the illustrated example, the portions of the input data (e.g., stored in the data buffer 122) at each node include:
Node 102: {d00, d01, d02, d03}
Node 104: {d10, d11, d12, d13}
Node 106: {d20, d21, d22, d23}
Node 108: {d30, d31, d32, d33}

In at least one example collective operation (e.g., all-reduce), the input data in each node is obtained from a memory and/or is generated from a prior computation (e.g., a prior data chunk) processed by the nodes 102, 104, 106, 108. As described in further detail below, the nodes 102, 104, 106, 108 collectively reduce the input data and distribute the reduced results among one another according to a multi-tree approach.

By way of example, the communication scheduler 124 generates a first set of schedule trees 202, 204, 206, 208. The first set of schedule trees indicate an order in which the nodes are to transmit data to one another. Dashed lines in the illustrated example indicate different levels of the generated multi-tree communication schedule (e.g., communication steps 210 and 211).

As a non-limiting example of collective communications according to the first set of schedule trees 202-208, at the first step 210, node 102 transmits ‘d03’ to node 104, node 104 transmits ‘d12’ to node 102, node 106 transmits ‘d21’ to node 108, and node 108 transmits ‘d30’ to node 106. In some examples, these transmissions are scheduled to be performed in parallel. In alternate examples, these transmissions occur at offset times (e.g., when a node is ready or available to transmit, when a data link is available, etc.). At the second step 211, node 104 transmits a reduced portion of the data (e.g., the result of the function ‘reduce(d13, d03)’) to node 108, node 106 transmits ‘d23’ to node 108, and so on. In this example, upon communicating and reducing the distributed input data (e.g., d00, d01, d02, d03, d10, d11, d12, d13, d20, d21, d22, d23, d30, d31, d32, d33) collectively according to the first set of schedule trees 202-208, the nodes 102, 104, 106, 108 include reduced data results as follows:
Node 102: R0=reduce(d00, d10, d20, d30)
Node 104: R1=reduce(d01, d11, d21, d31)
Node 106: R2=reduce(d02, d12, d22, d32)
Node 108: R3=reduce(d03, d13, d23, d33)

The ‘reduce’ function corresponds to any of a variety of reduction operations such as a sum, product, xor, among other possibilities, that receives input data elements and returns a reduced data element. For example, where the ‘reduce’ function is a sum function, R0 equals d00+d10+d20+d30, and so on.

Continuing with the example above, the communication scheduler 124 then generates a second set of schedule trees 212, 214, 216, 218 to schedule communications among the nodes so as to propagate or distribute (e.g., all-gather collective operation) the reduced data results among the plurality of nodes 102, 104, 106, 108. For instance, in accordance with a first step 220 of the schedule trees 212-218, node 102 transmits the reduced data result R0 to nodes 104 and 106, node 104 transmits R1 to nodes 102 and 108, and so on. The final results of the collective operation (e.g., all-reduce) is that each node includes the final reduced data results as follows:
Node 102: {R0, R1, R2, R3}
Node 104: {R0, R1, R2, R3}
Node 106: {R0, R1, R2, R3}
Node 108: {R0, R1, R2, R3}

In general, an implementation of all-to-all communication results in each of the nodes of the system having output data based on portions of the input data that were initially distributed among the plurality of nodes. It is noted that the multi-tree scheduling approach described herein accounts for network topology to minimize or reduce link congestion. Referring back to FIG. 1 for example, node 102 and 108 are not connected directly. Therefore, for example, communication scheduler 124 selects or otherwise determines an optimal route to communicate data between nodes 102 and 108 either via node 104 or via node 106.

In some scenarios however, one or more nodes in a group of nodes assigned to perform a collection operation experience delays (e.g., execution skew) that prevent the skewed nodes from communicating according to such a multi-tree approach. A skewed node is a node that is unavailable to contribute data for the collective operation when the skewed node is scheduled (e.g., according to the first set of schedule trees 202-208) to communicate. In one scenarios, for example, a skewed node executes other instructions (e.g., due to less performant computing hardware) such that the skewed node is not ready to transmit a data contribution for the collective operation (e.g., ‘d00’, ‘d01’, etc.) when scheduled to do so.

In at least one scenario, transmitting the delayed data from the skewed node at a later time results in link oversubscription because data links between the skewed node and the other nodes are scheduled to transmit other data packets. For example, consider a scenario where node 102 is skewed. In this scenario, at the first step 210 of schedule tree 202, the node 102 is not ready to transmit ‘d03’, which is used for computing R3 (R3=reduce(d03, d13, d23, d33)) to node 104. If node 104 waits for node 102 to be ready, then data reduction operations by node 108 to compute R3 are also delayed. Furthermore, if node 102 attempts to transmit ‘d03’ at a later time, in at least one scenario the link between nodes 102 and 104 is scheduled (e.g., at second step 211 of schedule tree 206) to communicate a different packet (e.g., ‘d01’).

One conventional approach to prevent link over-subscription due to skewed nodes is to implement a barrier before beginning the collective operation. With this approach, system 200 delays collective communication among nodes 102-108 until all the nodes are ready to contribute data for the collective operation according to the first set of schedule trees and the second set of schedule trees. However, such approach results in performance degradation as all the nodes may need to wait (e.g., remain idle) while waiting for the barrier. For instance, a collective operation assigned to hundreds or thousands of nodes may be delayed even if most of the nodes are non-skewed.

In accordance with the present disclosure, examples herein include a skew-tolerant multi-tree scheduling technique that enables multi-tree performance gains while accounting for delays associated with skewed nodes.

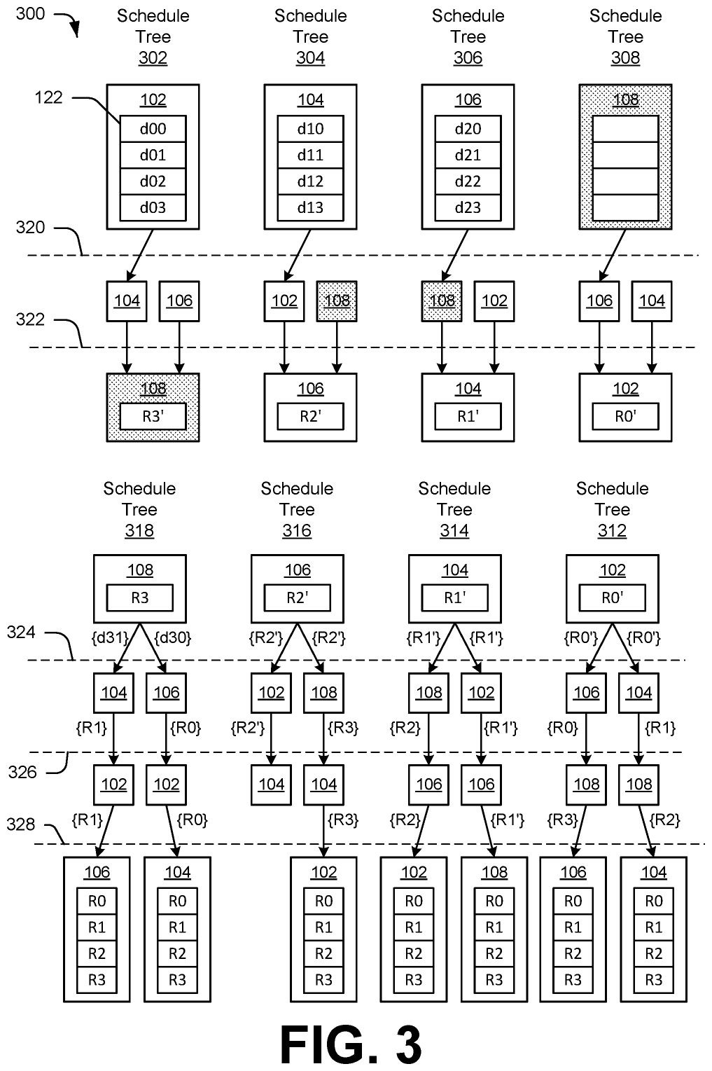

FIG. 3 depicts a non-limiting example system 300 in which collective communications are scheduled according to a skew-tolerant multi-tree approach. In the illustrated example, the nodes 102, 104, 106, 108 are assigned to a collective operation (e.g., all-reduce), similarly to the example of FIG. 2. However, in the scenario of FIG. 3, the node 108 is identified (e.g., by the Network interface controller 120, etc.) as a skewed node. For example, node 108 in this scenario is not ready to transmit {d30, d31, d32, d33} to the other nodes and/or reduced data in accordance with the first set of schedule trees 302, 304, 306, 308.

In accordance with the present disclosure, the data reduction logic 126 in the example system 300 is configured to identify node 108 as a skewed node and to trigger performing a first operation (e.g., a partial reduction operation) according to the first set of schedule trees 302-308 to generate partial results (i.e., partially reduced data) without using data contributed from the skewed node 108. For instance, at the first step 320, nodes 102, 104, 106 provide data contributions to, respectively, nodes 104, 102, and 108; but skewed node 108 does not provide a data contribution to 106. In an example, node 108 transmits an indication that to node 106 that it is skewed. In an alternative example, node 106 determines that node 108 is skewed and thus processes available data without waiting for data from node 108. At the second step 322, where node 108 is scheduled to transmit data to nodes 106 and 104, node 108 passes through available data to nodes 104 and 106 (e.g., data received from node 106 in the first step 320 is transmitted to node 104 without being combined or reduced to incorporate data contributed from the skewed node 108). As a result, upon executing the collective communications according to the first set of schedule trees 302-308, the nodes 102-108 include partially reduced data (or partial results) as follows:
Node 102: R0′=reduce(d00, d10, d20)
Node 104: R1′=reduce(d01, d11, d21)
Node 106: R2′=reduce(d02, d12, d22)
Node 108: R3′=reduce(d03, d13, d23)

Advantageously, the system 300 enables utilizing the non-skewed nodes 102, 104, 106 to perform a partial reduction of the input data instead of remaining idle (e.g., due to a barrier) while waiting for the skewed node 108 to be ready to contribute to the collective operation.

Next, in the illustrated example, the communication scheduler 124 generates a second set of schedule trees 312, 314, 316, 318, to simultaneously schedule communications for gathering the scattered partial reduction results and also to schedule combining data from the skewed node 108 with the partial results to generate final results. In an example, the system 300 triggers execution of the communications associated with the second set of schedule trees 312-318 upon determining that the delayed or skewed node 108 is ready to contribute data. In this example, the communication paths determined in the second set of schedule trees are optimized to reduce the number of steps needed to gather the partial results while also combining the delayed data from the skewed node 108.

To that end, the illustrated example, the second set of schedule trees 312-318 include three steps 324, 326, 328. At the first step 324, node 108 (i.e., the previously skewed node) reduces its data contribution (e.g., d33) with the partial reduction result (R3′) available therein to generate a final reduction result (R3); and transmits the delayed data contributions (e.g., d31, d30, etc.) to two adjacent nodes 104, 106. At the first step 324, the other nodes 102, 104, 106 also transmit their partial reduction results (R0′, R1′, R2′) to adjacent nodes. At the second step 326, the nodes 104, 106 (which received a data contribution from node 108 in the first step 324) further reduce the partial results stored therein and transmit their data to the next child node 102 in the schedule tree 318. Similarly, data communication between the nodes according to the schedule trees 312-318 as shown in FIG. 3 is performed. The result of the collective communications according to the second set of schedule trees 312-318 is that each of the nodes has the final results of the reduction process as follows, similarly to the final results described for the scenario of FIG. 2 (where all the nodes were non-skewed):
Node 102: {R0, R1, R2, R3}
Node 104: {R0, R1, R2, R3}
Node 106: {R0, R1, R2, R3}
Node 108: {R0, R1, R2, R3}

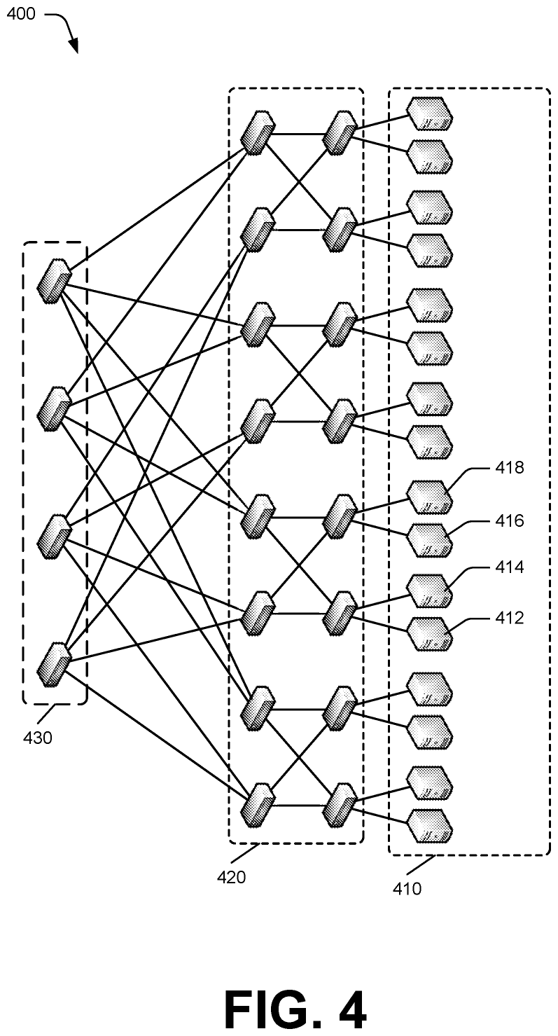

FIG. 4 depicts a non-limiting example system 400 having a fat-tree network topology and configured to perform a skew-tolerant multi-tree collective operation. The system 400 includes a network of nodes arranged to include an edge layer 410 (which includes nodes 412, 414, 416, 418, etc.), an aggregation layer 420, and a core layer 430. As noted earlier, the example techniques described herein can be implemented using any type of network topology such as the mesh network topology shown in FIG. 1 and/or the fat-tree network topology of the system 400.

In an example, a collective operation (e.g., all-reduce) is assigned to a network of nodes that includes sixteen nodes in the edge layer 410, exemplified by nodes 412, 414, 416, 418. In this example, if the assigned nodes are non-skewed, the communication scheduler generates schedule trees similarly to those described in FIG. 2 for scheduling data communications to reduce the input data and gather the reduced data in each of the nodes in layer 410.

In a scenario where nodes 412, 414, 416, 418 are skewed, similarly to the discussion of the system 300, the communication scheduler 124 generates a first set of schedule trees to generate partial reduction results (i.e., using data contributed from non-skewed nodes and/or without using data contributed from the skewed nodes 412-418). The data reduction logic 126 then performs a first operation (e.g., reduce/scatter) to generate partial reduction results according to the first set of schedule trees. The communication scheduler 124 also generates a second set of schedule trees to simultaneously schedule communications to generate final results by combining data from the skewed nodes with the partial results and to also distribute the final results among the nodes in the edge layer 410. The communication scheduler 124, in this example, accounts for the fat-tree network topology when choosing the optimal network paths to accomplish the collective communication goals of the first and second sets of schedule trees.

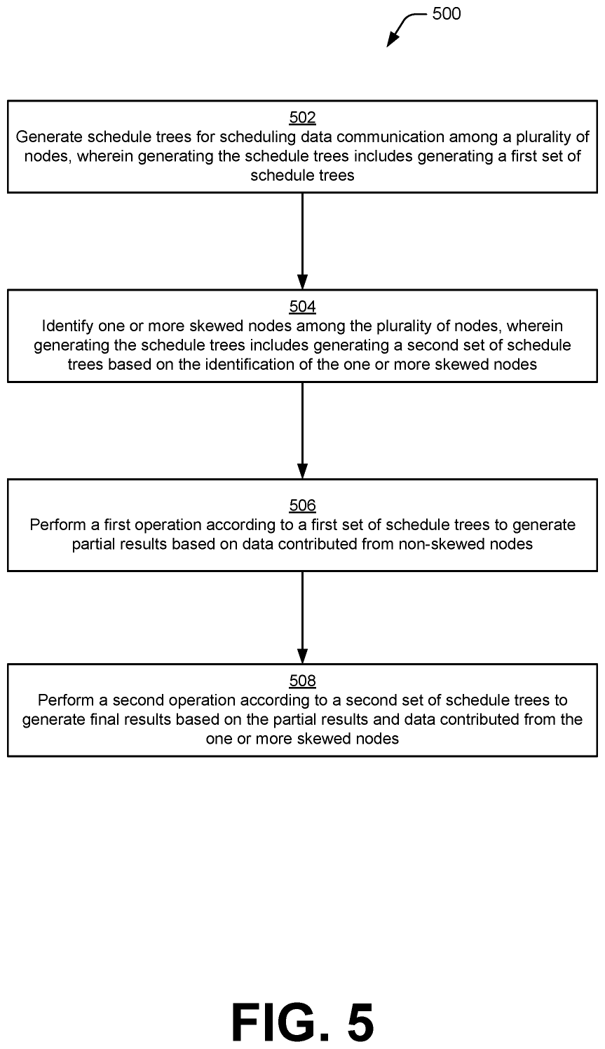

FIG. 5 depicts a procedure 500 in an example implementation of skew-tolerant multi-tree reduction. The order in which the procedure 500 is described is not intended to be construed as a limitation. In examples, any number or combination of the described operations is performed in any order to perform the procedure 500 or an alternate procedure, as described herein.

At block 502, a distributed computing system generates schedule trees to schedule multi-tree collective communications among a plurality of nodes assigned to perform a collective. For example, the communication scheduler 124 of system 100 generates schedule trees to schedule collective communications (e.g., data 110, 112, 114) among the plurality of nodes 102, 104, 106, 108. In some examples, generating the schedule trees at block 502 includes generating a first set of schedule trees 302-308.

At block 504, the system identifies one or more skewed nodes among the plurality of nodes. For example, the data reduction logic 126 determines which of the plurality of nodes is delayed or skewed. In this example, the Network interface controller 120 maintains the bitmap 128, which includes a bit for each of the plurality of nodes or any other indication of the status of each node (e.g., whether node is skewed or non-skewed).

In an example, when any of the nodes 102, 104, 106, 108 calls an API for a collective operation (e.g., a skew-tolerant all-reduce operation), the data reduction logic 126 initiates a bitmap all-reduce (e.g., ‘OR’) operation across all the participating nodes at regular intervals of time (e.g., epoch) to generate a final reduced bitmap. The final reduced bitmap indicates which nodes are ready (i.e., non-skewed) or not ready (skewed) to contribute data for the collective operation. In this example, the bitmap 128 is relatively smaller in size than the input data that is to be reduced when the actual skew-tolerant collective operation is executed, and thus computing the bitmap via the bitmap all-reduce operation is associated with relatively lower overhead. In one implementation, the Network interface controller 120 initiates bitmap all-reduce operations once every epoch whereas the actual skew-tolerant all-reduce operation is executed when a user-defined number of nodes are deemed to be non-skewed (i.e., available to contribute data for the collective operation).

In an alternate example, information about delayed nodes (e.g., skewed nodes) is obtained at block 504 by executing a custom barrier. In this example, instead of using a conventional blanket barrier that waits for all the nodes to become non-skewed, executing the custom barrier returns an indication of which nodes are ready (i.e., non-skewed) and which nodes are not ready (e.g., skewed). In this example, the result of the custom barrier can be used to decide when to trigger performing a first operation to generate partial reduction results. In one implementation, the data reduction logic 126 triggers performance of the first operation based on a determination that at least a threshold number of nodes in the group of nodes assigned to perform the collective operation are non-skewed (or ready to contribute data). The threshold number of nodes is user-defined (e.g., user sets the threshold in the API call), predefined (e.g., a default threshold is applied), or determined dynamically by the data reduction logic 126 to optimize the skew-tolerant collective operation (e.g., based on size of the input data, number of assigned nodes, and/or other factors).

In some examples, identifying the one or more skewed nodes (at block 504) includes performing a probe operation. In an example, the network interface controller 120 performs any of the probe operations (e.g., bitmap reduction, custom barrier, etc.) described above. Further, in an example, the network interface controller 120 updates a bit for each of the plurality of nodes such that the bit is indicative of whether a corresponding node is available to contribute data for the collective operation (e.g., a bit value of ‘1’ to indicate node is non-skewed and ‘0’ to indicate node is skewed, or vice versa).

In some examples, the procedure 500 includes generating the second set of schedule trees based on the identification of the one or more skewed nodes (at block 504). For example, the second set of schedule trees 312-318 define communication paths that include (previously skewed) node 108.

At block 506, procedure 500 includes performing a first operation (e.g., a modified reduce-scatter, etc.) according to a first set of schedule trees to generate partial results based on data contributed from non-skewed nodes. For example, the data reduction logic 126 performs the first operation according to the first set of schedule trees 302, 304, 306, 308 to generate partial results (e.g., R0′, R1′, R2′, R3′), by partially reducing the input data using data contributed from non-skewed nodes 102, 104, 106 (e.g., R0′=reduce(d00, d10, d20)) without data contributions from skewed node 108 (e.g., d30). If a skewed node is scheduled to transmit a data contribution in the first set of schedule trees, the skewed node instead passes data it currently has without incorporating its own contribution. For instance, at step 322 of schedule tree 306, node 108 passes the data it received from node 106 (d21) to node 104.

At block 508, procedure 500 includes performing a second operation (e.g., a modified all-gather operation) according to a second set of schedule trees to generate final results based on the partial results and data contributed from the one or more skewed nodes (identified at block 504). For example, the data reduction logic 126 performs the second operation by scheduling communication paths (as indicated by the second set of schedule trees 312, 314, 316, 318) to optimally combine data contributed from previously skewed node 108 with the partial results (generated at block 506) to generate the final results (e.g., R0=reduce (d00, d10, d20, d30)), while also propagating the final results (e.g., R0, R1, R2, R3) among the plurality of nodes 102, 104, 106, 108.

In some examples, the procedure 500 includes triggering performance of the second operation of block 508 in response to a determination that at least one of the one or more skewed nodes is available to contribute data according to the second set of schedule trees. For example, the system 300 delays performing the second operation until node 108 is ready to contribute data. In one example, a system performing the procedure 500 triggers performing the second operation in response to a determination that all of the skewed nodes are available to contribute data according to the second set of schedule trees. Alternatively, the system triggers performing the second performance when one, two, three, or any other threshold number of previously skewed nodes become available to contribute data according to the second set of schedule trees.

In some examples, performing the second operation at block 508 includes distributing or broadcasting or propagating the final results across the plurality of nodes. Referring back to FIG. 3 for example, the final results (R0, R1, R2, R3) are propagated to the nodes 102, 104, 106, 108 by performing the second operation according to the second set of schedule trees 312, 314, 316, 318.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the processing element 116, the memory 118, the Network interface controller 120, the data buffer 122, the communication scheduler 124, the data reduction logic 126, and/or the bitmap 128) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system comprising:
a communication scheduler to generate schedule trees for scheduling data communication among a plurality of nodes configured to perform a collective operation using data contributed from the plurality of nodes; and
data reduction logic to:
identify one or more skewed nodes among the plurality of nodes,
perform, according to a first set of schedule trees, a first operation to generate partial results based on data contributed from non-skewed nodes, and
perform, according to a second set of schedule trees, a second operation to generate final results based on the partial results and data contributed from the one or more skewed nodes.

2. The system of claim 1, wherein the data reduction logic is configured to identify a skewed node based on a determination that the skewed node is unavailable to contribute data according to the first set of schedule trees.

3. The system of claim 1, wherein the data reduction logic is to perform the first operation to generate the partial results without the data contributed from the one or more skewed nodes.

4. The system of claim 1, wherein the communication scheduler is to generate the second set of schedule trees based on identifying the one or more skewed nodes.

5. The system of claim 1, wherein to perform the second operation according to the second set of schedule trees the data reduction logic is further configured to distribute the final results to the plurality of nodes.

6. The system of claim 1, further comprising a network interface controller configured to perform a probe operation and the data reduction logic identifies the one or more skewed nodes based on the probe operation.

7. The system of claim 6, wherein the network interface controller is to update, based on the probe operation, a bitmap that includes a bit for each of the plurality of nodes, wherein the bit is indicative of whether a corresponding node is available to contribute data for the collective operation.

8. The system of claim 1, wherein the data reduction logic is further configured to trigger performance of the second operation in response to a determination that at least one of the one or more skewed nodes is available to contribute data according to the second set of schedule trees.

9. The system of claim 1, wherein the data reduction logic is further configured to trigger performance of the second operation in response to a determination that all the one or more skewed nodes are available to contribute data according to the second set of schedule trees.

10. The system of claim 1, wherein the data reduction logic is further configured to trigger performance of the first operation in response to a determination that at least a threshold number of the plurality of nodes are non-skewed.

11. A method comprising:
generating schedule trees for scheduling data communication among a plurality of nodes configured to perform a collective operation;
identifying one or more skewed nodes among the plurality of nodes;
performing, according to a first set of schedule trees, a first operation to generate partial results based on data contributed from non-skewed nodes; and
performing, according to a second set of schedule trees, a second operation to generate final results based on the partial results and data contributed from the one or more skewed nodes.

12. The method of claim 11, further comprising:
identifying a skewed node based on a determination that the skewed node is unavailable to contribute data according to the first set of schedule trees.

13. The method of claim 11, further comprising performing the first operation to generate the partial results without the data contributed from the one or more skewed nodes.

14. The method of claim 11, further comprising generating the second set of schedule trees based on identifying of the one or more skewed nodes.

15. The method of claim 11, further comprising broadcasting the final results to the plurality of nodes.

16. A method comprising:
generating schedule trees for scheduling collective communications among a plurality of nodes;
identifying one or more skewed nodes among the plurality of nodes;
performing, according to a first set of schedule trees, a first operation to generate partial results based on data contributed from non-skewed nodes; and
performing, according to a second set of schedule trees, a second operation to generate final results based on the partial results and data contributed from the one or more skewed nodes.

17. The method of claim 16, wherein a skewed node is a node that is unavailable to contribute data according to the first set of schedule trees.

18. The method of claim 16, further comprising performing the first operation to generate the partial results without the data contributed from the one or more skewed nodes.

19. The method of claim 16, further comprising generating the second set of schedule trees based on identifying the one or more skewed nodes.

20. The method of claim 16, further comprising propagating the final results to the plurality of nodes.
